(19) United States
(12) Patent Application Publication
(10) Pub. No.: US 2006/0031413 A1
(43) Pub. Date: Feb. 9, 2006

(54) Computer systems and methods for providing failure protection

(76) Inventor: Achim Enenkiel, Karlsruhe (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/109,725

(22) Filed: Apr. 20, 2005

(30) Foreign Application Priority Data
Apr. 28, 2004 (EP) 04010067.9

(51) Int. Cl. G06F 15/16

(52) U.S. Cl. 709/219

(57) ABSTRACT

Computer systems and methods are provided for providing failure protection. In one implementation, a data processing system is provided, such as a client-server system. The data processing system uses one or more web services as potential replacement(s) if a server computer and/or a component that is used by the server computer for providing a particular data processing service becomes unavailable.

### TECHNICAL FIELD

The present invention generally relates to the field of data processing. More particularly, embodiments of the invention relate to computer systems and methods with failure resistant data processing techniques.

### BACKGROUND INFORMATION

Many of today's database architectures rely on a central database approach. A central database has the advantage of providing a single point of access for data storage, and quick and efficient searching.

On the down side, a single centralized database also provides a single point of failure. For example, the server hosting the centralized database may go down. Without a redundant system in place, such as mirroring, the loss of the server will generally enforce a network-wide work stoppage.

The same applies to data processing services provided by so-called World-Wide-Web (“WWW” or “web”) services. Web services are an emerging technology that offer the dual promise of simplicity and pervasiveness. Web services represent the next level of function and efficiency in e-business. A web service can be viewed as any mechanism by which an application or data processing service can be provided to other applications on the Internet.

Web services may be informational or transactional. That is, some services provide information of interest to the requestor, while other services may actually lead to the invocation of business procedures. Examples of publicly available web services today include stock quote services, services to retrieve news from web-based news sources, and currency conversion services. For more detailed information on web services technology, reference is made to the following:
http://www. microsoft.com/germany/ms/msdnbiblio/show_all.asp?siteid=450884;
http://www.w3.org/TR/wsdl.html;
http://www. microsoft.com/germany/ms/msdnbiblio/show_all.asp?siteid=600570;
http://n.ethz.ch/student/jodaniel/37-310/slides/UDDI_MarcoCicolini.ppt;
http://n.ethz.ch/student/jodaniel/37-310/slides/UDDI_DominikKaspar.ppt; and
http://www. microsoft.com/germany/ms/msdnbiblio/show_all.asp?siteid=600156.

Services responsive to simple object access protocol (SOAP) messages are one example of a web service. SOAP is an application invocation protocol that defies a protocol for exchanging information encoded as XML messages. Normally, these services are described by WSDL (Web Service Description Language) notation stored in WSDL documents. A WSDL document can be stored in numerous ways, such as in a file, in a DB2 XML registry/repository, or in a DB2 based UDDI registry, for example. UDDI (Universal Description, Discovery, Integration) is a protocol for describing Web services such that interested parties may easily discover them. Specifications for this registry and use of WSDL in the registry are available at http://www.uddi.org/. Service providers may register their services in a UDDI, specifying technical information about how to invoke the service. Often, a WSDL document is stored in a UDDI registry in order to define the messages a particular web services accepts and generates.

The design of UDDI allows enterprises that own web service enabled applications to publish data about themselves and their services. By providing this information, UDDI implements a simplified form of searching for those interested in locating a particular service in which to fulfill an application process. The conventional UDDI search is focused on single search criteria, such as business name, business location, business categories, business identifier, service type by name, and discovery URL (Uniform Resource Locator).

Various approaches for implementing web services are known, such as from the following: U.S. Published patent application Nos. 2003/0093436 A1, 2003/0055868 A1, 2003/0055624 A1, 2003/0018661 A1, 2003/0110242 A1, 2003/0163513 A1, 2004/0064503 A1, 2004/0045005 A1, 2004/0003130 A1, and 2003/0187841 A1.

However, a common disadvantage of web services is that they present a single point of failure, just like common central databases do. If a web service fails, the respective informational and/or transactional data processing service provided by the web service becomes unavailable. By way of example, this can be caused by a failure of the web server that provides the web service.

### SUMMARY

Embodiments consistent with the present invention provide computer systems and methods with failure resistant data processing techniques. In one embodiment, a server computer system is provided that includes means for receiving a request from a client computer system. The server computer system also includes means for accessing a data processing component for processing the request. The data processing component can be an integral part of the server computer system or an external component that is closely or loosely coupled to the server computer system. For example, the data processing component may be an internal or external database.

As disclosed herein, the means for accessing the data processing component may be adapted to send the client's request to a web service, if the data processing component becomes unavailable. The web service that receives the request from the server computer system may perform substantially the same data processing service, such as informational and/or transactional data processing services, as the default data processing component. Hence, the web service provides a backup for the data processing component, which makes the server computer system more failure resistant with respect to data processing services provided in response to client requests. In fact, depending on the properties of the selected web service, the requesting client may not even recognize that a failure of the default data processing component of the server computer system has occurred as the same or a substantially similar result is provided from the web service.

This approach has the advantage of providing a single point of access for receiving the client request while avoiding the single point of failure problem.

In accordance with an embodiment of the invention, the server computer system includes storage means for storing a locator of the web service. For example, a pre-defined URL of the web service and a WSDL description of the web service is stored in the storage means. In case of failure of the default data processing component, the web service is accessed using the URL and WSDL description stored in the storage means.

In accordance with another embodiment of the invention, a plurality of web services is used as potential replacements for the default data processing component. The plurality of web services can be pre-selected and stored in a static or dynamic list.

A dynamic list of potential replacement web services for the failing data processing component can be provided by querying a UDDI in order to identify a plurality of web services that match a given profile. The query returns a set of web services that offer similar data processing services as the data processing component. A ranking value is calculated for each web service of the plurality of web services which are thus identified. The ranking value can be calculated using a pre-defined criterion, such as the cost of the web service, its availability, the quality of the services provided, etc.

After the dynamic list of web services has been generated, an attempt may be made to access the web service having the highest ranking value in the list. If the highest ranking web service of the dynamic list is unavailable or does not deliver a desired result, an access attempt to the second highest ranking web service of the dynamic list is made, etc., until an operational web service in the list is found.

For example, a web service of a supplier provides information regarding availability and cost of a service, product or material required by a client. If the web service does not deliver a desired result, i.e., an offer that meets the client's requirements in terms of cost and/or availability, the next web service on the list is used, etc.

In accordance with a further embodiment of the invention, the format of the request received from the client computer system is transformed to a format in compliance with the WSDL description of the replacement web service. Likewise, the format of the web service's response is transformed back into the domain of the client computer system. Again, the WSDL description of the web service can be used as an input parameter for performing the back transformation.

Embodiments of the present invention further relate to client computer systems. In one embodiment, a client computer system is provided that is coupled to a server computer system that provides a data processing service to the client computer system. When the server computer system becomes unavailable, the client computer system resends its request for the data processing service to a replacement web services. As in the server computer embodiments, the client computer system can store a predefined URL and WSDL of a single web service that can act as a replacement in case of failure of the server computer system or a static list of potential replacement web services. As a further alternative, a dynamic list of potential replacement web services may be generated in response to failure of the server computer system.

Embodiments of the present invention also relate to data processing systems. In one embodiment, a data processing system is provided that includes a plurality of client computer systems and at least one server computer system that provides data processing services to the client computer systems. Both the client computer systems and the server computer system store one or more locators of potential replacement web services in case of failure of the server computer system and/or failure of the default data processing component that is accessed by the server computer system for providing the data processing service.

Using the above approach, a two stage mechanism is provided as a failure protection. The first stage is constituted by the server computer system. If the default data processing component used by the server computer system for providing the data processing service fails, the server computer system forwards the client request for the data processing service to a replacement web service. The second stage for the failure protection is constituted by each individual client computer system. If the server computer system itself goes down, it cannot provide access to one of the replacement web services. In this case, an afflicted client computer system autonomously determines a replacement web service and re-sends its requests to the replacement web service.

If, for example, static lists containing locators of potential replacement web services are stored both in the server computer system and the client computer systems, and if the default data processing component used by the server computer system for providing the data processing service fails, the server computer system uses its static list of web services in order to identify a replacement web service. If the server computer system itself goes down, the afflicted client computer systems use their private static lists in order to autonomously identify respective replacement web services.

In order to limit the administrative overhead for maintaining static lists of replacement web services in the server computer system and the client computer systems, it is preferred that the static list of the server computer system is updated more frequently than the static lists in the client computer systems.

Additional objects and advantages of embodiments consistent with the invention will be set forth in part in the description which follows, and in part will be obvious from the description, or may be learned by practice of embodiments of the invention. The objects and advantages of embodiments of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain principles consistent with the present invention. In the drawings:

FIG. 1 is a block diagram of an embodiment of a failure resistant data processing system;

FIG. 2 shows a flowchart of an exemplary method for operating the data processing system of FIG. 1;

FIG. 3 is a block diagram of another embodiment of a failure resistant data processing system;

FIG. 4 shows a flowchart of an exemplary method for generating an assorted list of potential replacement web services;

FIG. 5 is a block diagram of an alternative embodiment to the exemplary data processing systems of FIGS. 1 and 3; and

FIG. 6 shows a flowchart of an exemplary method for operating the data processing system of FIG. 5.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

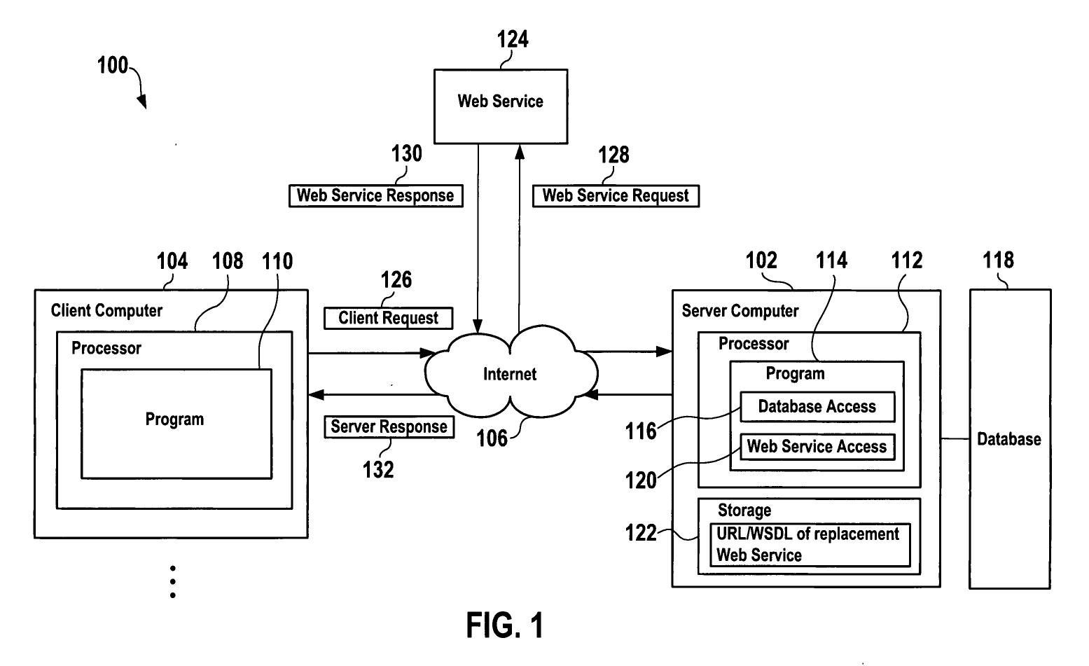

FIG. 1 shows an exemplary data processing system 100, consistent with an embodiment of the present invention. As shown, system 100 includes at least one server computer 102. Further, a plurality of client computers are coupled to server computer 102 via a computer network, such as Internet 106. For convenience of explanation only client computer 104 is considered in the following description.

Client computer 104 includes a processor 108 for running a program 110. Program 110 may implement the HTTP protocol for communicating with server computer 102 via Internet 106.

Likewise, server computer 102 includes a processor 112 for running program 114. Program 114 implements the HTTP protocol for communicating with client computer 104. Program 114 includes a program module 116 for accessing a database 118 that is coupled to server computer 102. Further, program 114 includes a program module 120 for accessing a web service.

Server computer 102 includes a storage 122 for storing the URL and the WSDL description of a replacement web service 124.

In operation, program 110 of client computer 104 sends client request 126 to server computer 102 via Internet 106. Client request 126 can be of an informational or transactional nature depending on the application. For example, client request 126 specifies a database query.

When server computer 102 receives client request 126, program module 116 is invoked in order to execute the query as specified in client request 126. When database 118 is unavailable, program module 120 is invoked.

Program module 120 reads the URL of the replacement web service 124 from storage 122, as well as the WSDL description of the replacement web service. Program module 120 reformats client request 126 in order to generate web service request 128 that is in compliance with the WSDL description of replacement web service 124. If client request 126 has a format that is acceptable to web service 124, no such reformatting is necessary.

Program module 120 sends web service request 128 to web service 124 via Internet 106. Web service 124 returns web service response 130 to server computer 102. Web service response 130 is reformatted in order to transform it back into the client domain, if necessary. The resulting server response 132 is sent from server computer 102 to client computer 104 via Internet 106.

By way of example, server computer 102 may belong to an operator of a wireless mobile telecommunication network. In such an embodiment, subscriber information of registered users of the telecommunication network is stored in database 118. This information includes the payment histories of the subscribers and a credit rating.

Further, client computer 104 may be located at a point-of-sale that offers subscription agreements for the telecommunication network. When an individual enters the point-of-sale and requests a subscription agreement, personal data that unequivocally identify the individual, such as the individual's name and birthday, are entered into client computer 104.

Client request 126 contains the individual's name and birthday in order to specify a corresponding database query. If database 118 is available, it is checked by querying database 118 whether the individual is already a subscriber. If this is the case, credit rating information is returned from database 118 and sent to client computer 104 by means of server response 132. Based on the credit rating information, the subscriber's request for entering an additional subscription agreement can be accepted or declined. This is especially important if the subscription agreement encompasses the sale of a subsidized cellular phone. Only if the subscriber is sufficiently credit worthy, the operator has a reasonable chance of recovering the cost for the subsidized cellular phone that is given to the subscriber as a part of the additional subscription agreement.

If database 118 becomes unavailable due to a hardware or software failure or due to servicing, program module 120 is invoked. Program module 120 reads the URL of a replacement web service that delivers credit rating information. Examples of such web services include, for example, Dunn & Bradstreet, Credit Reform, etc. Program module 120 transforms client request 126 into web service request 128 using the WSDL description of the replacement web service.

The web service response 130 containing the requested credit rating information of the individual is received by server computer 102 and is transformed back by program module 120 into the format of the client domain. The resulting server response 132 containing the credit rating information is sent back to client computer 104. As a result, client computer 104 receives the same or substantially similar information as to the individual's credit rating. This has the advantage that an informed decision can be made regarding acceptance or refusal of the individual's request for entering a subscription agreement.

It is to be noted that server computer 102 can also use web service 124 if the requested credit rating information is not stored in its database 118. This can be due to the fact that the individual is not a subscriber and/or due to corruption of database 118. In both instances, the requested information is not available from the default resource, i.e., database 118, such that replacement web service 124 is used instead.

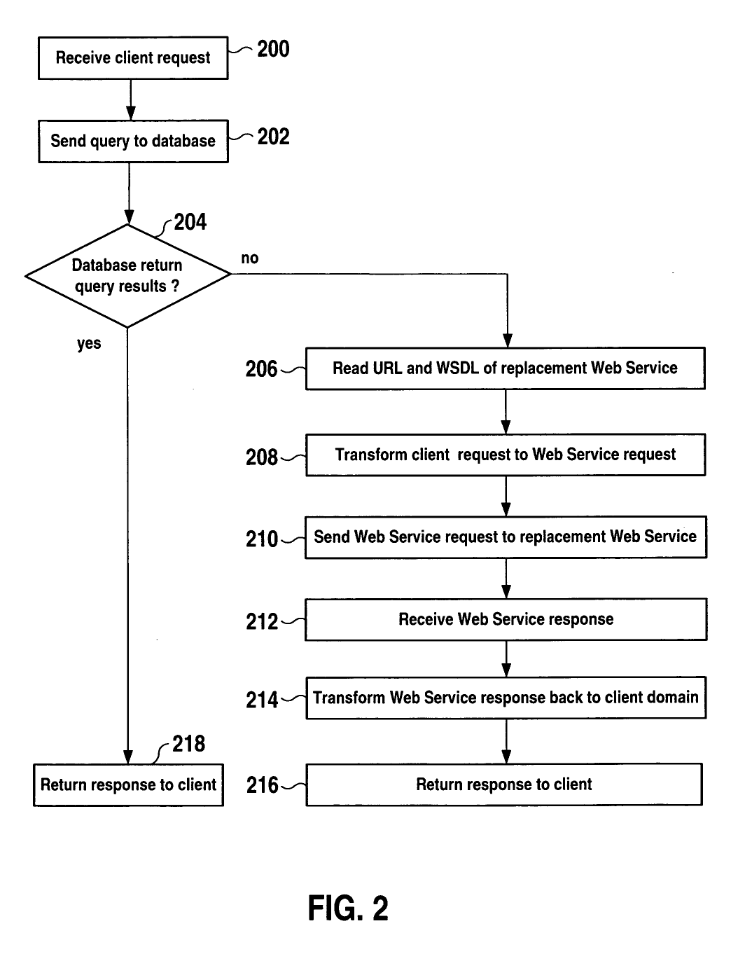

FIG. 2 shows a flowchart of an exemplary method for operating the data processing system of FIG. 1. In step 200, the server computer receives the client request. The client request can be of an informational or transactional nature. For example, the client request specifies a database query.

In step 202, the server computer sends the query that is specified in the client request to the database. The database can be closely or loosely coupled to the server computer. In particular, the database can be an integral part of the server computer or it can be an external database. For example, the database is provided by a default web service. In this case, the server computer performs the database access via the Internet.

In step 204, the server computer determines whether a query result has been received. For example, if no result has been received within a predefined time window after the query has been sent in step 202, the server computer's determination is that the database is unavailable. In this case, the control goes to step 206 where the URL and WSDL of a replacement web service is read. In step 208, the client request is transformed to a corresponding web service request. Preferably, the transformation is performed using the WSDL description of the replacement web service in order to bring the client request into conformity with the format and structure of messages that are acceptable by the replacement web service.

In step 210, the web service request is sent to the replacement web service via the Internet using the URL read in step 206.

In step 212, a response is received from the replacement web service containing the query result. The web service response is transformed back to the client domain in step 214. Again, the WSDL of the replacement web service can be used for the back transformation for inversion of the transformation from the client domain to the web service domain. In step 216, the resulting response is returned to the client.

If the database is available the control goes directly from step 204 to step 218, where the response provided by the database is returned to the client.

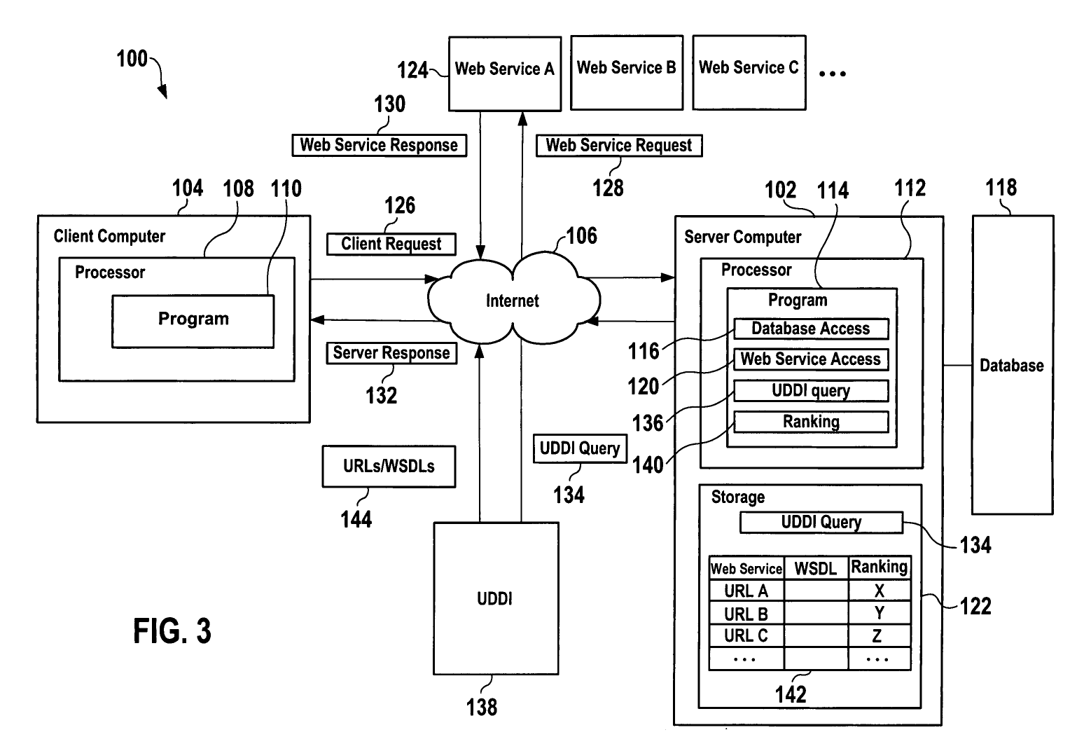

FIG. 3 is a block diagram of another exemplary data processing system 100, consistent with an embodiment of the invention. Elements of FIG. 3 that correspond to elements of FIG. 1 are designated by the same reference numerals.

In contrast to the embodiment of FIG. 1, with system 100 of FIG. 3 the replacement Web service that is to be used in case of failure of database 118 is not predefined. Rather, storage 122 stores a predefined UDDI query 134. Program 114 includes an additional program module 136 for reading UDDI query 134 and sending it to UDDI 138 via Internet 106. Further, program 114 has program module 140 for calculating ranking values for the potential alternative web services returned from UDDI 138. For example, a ranking value is calculated using a number of predefined criteria such as the cost, availability, coverage, last update, etc., of a given web service or a combination of such criteria.

In one embodiment, the results are stored as a table 142 in storage 122.

In operation, server computer 102 receives a client request 146, as in the embodiment of FIG. 1 or 2. When database 118 is unavailable, program module 136 is invoked. Program module 136 reads UDDI query 134 from storage 122 and sends UDDI query 134 to UDDI 138.

UDDI 138 returns response 144 that contains the URLs and WSDLs of the web services registered in UDDI 138 that match UDDI query 134. When server computer 102 receives response 144, program module 140 is invoked in order to calculate a ranking value for each of the potential replacement web services identified in response 144. The web services are sorted by the ranking values which provides table 142 that is stored in storage 122.

In the example considered here, response 144 identifies a plurality of web services A, B, C, . . . together with the respective WSDL descriptors. Program module 140 calculates a ranking value for each of these web services, such as ranking value X for web service A, ranking value Y for web service B, ranking value Z for web service C, etc.

After table 142 has been generated and stored in storage 122, program module 120 is invoked. Program module 120 reads the URL of the highest ranking web service identified in table 142. In the example considered here, this is the URL A of web service A 124. Program module 120 also reads the WSDL descriptor of web service A from table 142 in order to transform client request 126 to web service request 128.

Program module 120 sends web service request 128 to web service A 124. Upon receipt of web service response 130, it transforms the web service response 130 back into the client domain to provide server response 132. However, if no web service response 130 is received from web service A 124 within a predefined time, window program module 120 reads the URL and WSDL descriptor of the second highest ranking Web service B from table 142 in order to attempt usage of the web service B as a replacement for database 118. If web service B is also unavailable, an attempt is made to use the next highest ranking web service C instead, etc.

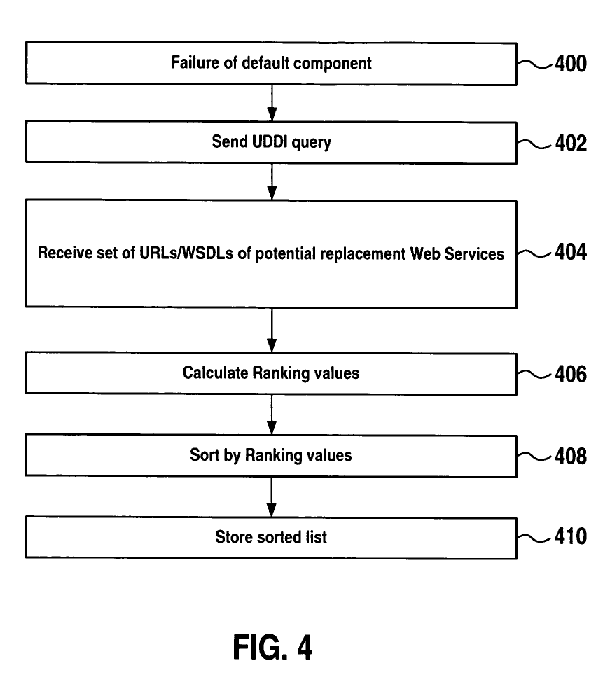

FIG. 4 illustrates a flowchart of an exemplary method for generating table 142 stored in storage 122 in the embodiment of FIG. 3. In step 400, failure of a default component that usually provides a given informational and/or transactional data processing service is diagnosed by the server computer. In the embodiment considered in FIG. 3, the default component is database 118.

In step 402, the UDDI query is read from the storage of the server computer and sent to the UDDI via the Internet.

In step 404, a set of URLs and respective WSDLs is received. The set of URLs identifies potential replacement web services that match the UDDI query. In step 406, ranking values are calculated for the web services identified in the set received in step 404. In step 408, the web services are sorted by their ranking values and the resultant sorted list is stored in step 410. In the example considered in FIG. 3, the sorted list provides table 142.

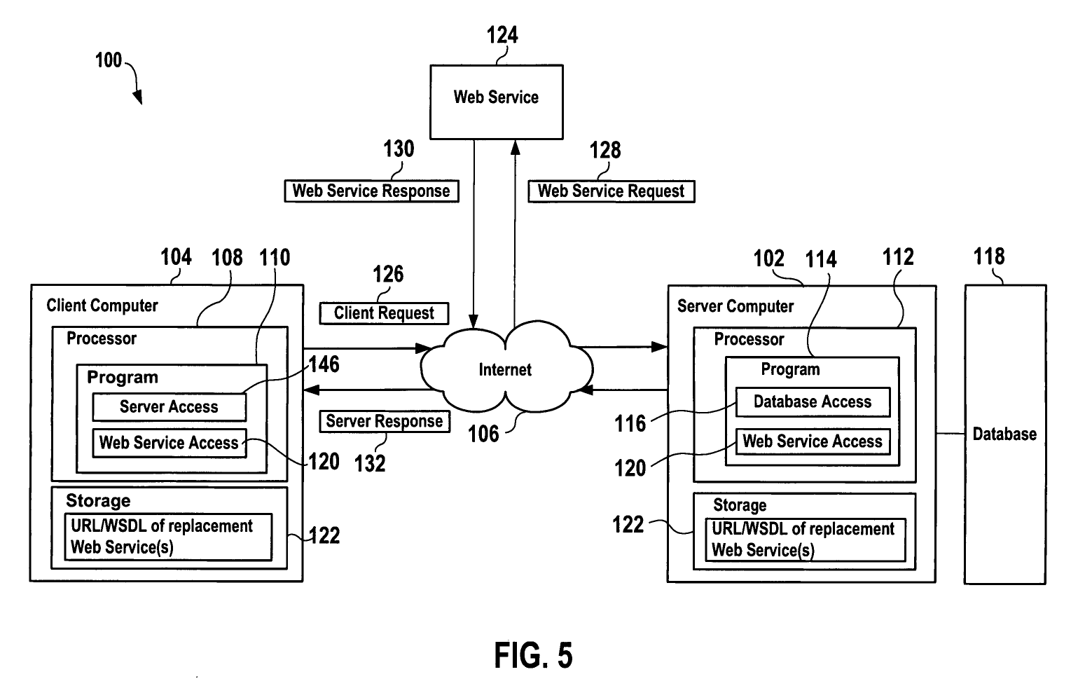

FIG. 5 is a block diagram of another exemplary embodiment of data processing system 100. Elements in the embodiment of FIG. 5 that correspond to elements in the embodiments of FIG. 1 or 3 are designated by the same reference numerals.

In the embodiment of FIG. 5, server computer 102 is substantially identical to server computers 102 of FIG. 1 or 3. However, in contrast to the embodiments of FIGS. 1 and 3, program 110 of client computer 104 also has a program module 120 for accessing replacement web service 124. Further, program 110 includes a program module 146 for accessing server computer 102 via Internet 106 and a storage 122 for storage of the URL(s) of one or more potential replacement web services in a static or dynamic list. Preferably, an application program runs on processor 108. By means of the application program, a client request 126 can be specified and entered into the program 110.

In operation, program module 146 sends client request 126 to server computer 102 via Internet 106. When database 118 is not available, server computer 102 uses the replacement web service 124 in order to provide server response 132 to client computer 104. If server computer 102 is down, client computer 102 does not receive server response 132 within a given time frame.

In this case, program module 120 of program 110 is invoked in order to directly access replacement web service 124 from client computer 104. In this scenario, program module 120 of program 110 internally transforms client request 126 to web service request 128 in order to send web service request 128 from client computer 104 to web service 124. Web service response 130 is received by program module 120 of program 110 of client computer 104 and is transformed back into the client computer's domain.

Advantageously, the embodiment of FIG. 5 can provide protection against failure of server computer 102. If server computer 102 is down, client computer 104 can directly access a replacement web service in order to obtain the required informational and/or transactional data processing service.

In case static lists of replacement web services are stored in storages 122 of the client computers 104 and server computer 102, it is advantageous to minimize the administrative overhead involved in maintaining these static lists by updating the static lists stored in the client computers 104 less frequently than the static list stored in storage 122 of server computer 102. This takes into account that failure of server computer 102 is a relatively unlikely event.

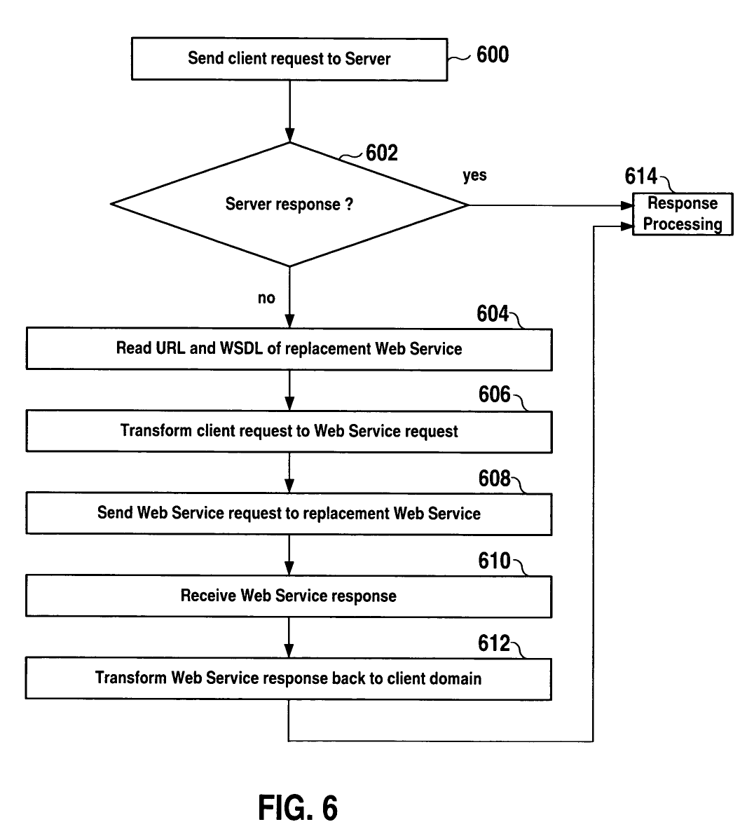

FIG. 6 illustrates a flowchart of an exemplary method for operating the embodiment of data processing system 100 of FIG. 5. In step 600, the client request is sent to the server computer. In step 602, it is determined whether a response is received from the server within a predefined time frame after sending the client request.

If no response is received within the time frame, the control goes to step 604 where the URL and WSDL of a replacement web service is read from the storage of the client computer. In step 606, the client request is transformed into a web service request in compliance with the WSDL descriptor of the replacement web service. In step 606, the web service request is sent from the client computer to the replacement web service. In step 610, the client computer receives the web services response which is transformed back into the client domain in step 612 by reformatting the web service response into a format understandable by an application program of the client computer that requires the response. In step 614, the response is processed by the application program.

If a server response is received, the control directly goes from step 602 to step 614 instead, as shown in FIG. 6.

Embodiments of the invention can be implemented in digital electronic circuitry, or in computer hardware, firmware, software, or in any combination thereof. Embodiments of the invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods consistent with the present invention can be performed by one or more programmable processors executing a computer program to perform functions or steps of such methods by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, embodiments of the invention can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Other embodiments of the invention will be apparent to those skilled in the art from consideration of the specification and practice of embodiments of the invention disclosed herein. It is intended, therefore, that the specification and examples be considered as exemplary only, with a true scope and spirit of the invention being indicated by the following claims.

What is claimed is:

1. A server computer system, comprising:
means for receiving a request from a client computer system; and
means for accessing a data processing component for processing the request and for sending the request to a web service if the data processing component is unavailable.

2. The server computer system of claim 1, wherein the data processing component is a database.

3. A client computer system, comprising:
means for sending a request to a server computer system; and
means for sending the request to a web service if the server computer is unavailable.

4. The computer system of claim 1 or 3, further comprising storage means for storing a locator of the web service.

5. The computer system of claim 1 or 3, further comprising storage means for storing a list of web services.

6. The computer system of claim 5, wherein the list of web services is static.

7. The computer system of claim 5, wherein the list of web services is dynamic, and wherein the computer system further comprises:
means for accessing a directory to identify a plurality of web services; and
means for ranking the plurality of web services.

8. The computer system of claim 7, further comprising means for selecting one of the web services from the list using the ranking as a selection criterion.

9. The computer system of claim 1 or 3, further comprising means for transforming a first format of the request into a second format of the web service.

10. The computer system of claim 9, the means for transforming being adapted to receive a description of the web service as an input for performing the transformation.

11. The computer system of claim 1 or 3, further comprising means for transforming a first format of a response of the web service into a second client format.

12. The computer system of claim 11, the means for transforming the first format of the response being adapted to receive a description of the web service as an input for performing the transformation.

13. A data processing system, comprising:
a plurality of client computer systems, each client computer system comprising:
means for sending a request to a server computer system,
means for sending the request to a web service if the server computer is unavailable, and
storage means for storing a locator of a web service, and
a server computer system coupled to the plurality of client computer systems, the server computer system comprising:
means for receiving a request from a client computer system,
means for accessing a data processing component for processing the request and for sending the request to a web service, if the data processing component is unavailable, and
storage means for storing a locator of a web service.

14. A computer program product, the computer program product comprising computer executable instructions for providing a request to a data default data processing component, and computer executable instructions for providing the request to a web service as a replacement for the default data processing component if the default data processing component becomes unavailable.

15. The computer program product of claim 14, further comprising computer executable instructions for selecting the web service from a plurality of web services.

16. The computer program product of claim 15, wherein the instructions use a predetermined selection criterion for selection of the web service from the plurality of Web services.

17. The computer program product of claim 15, further comprising computer executable instructions for calculating a ranking value for each web service of the plurality of web services.

18. The computer program product of a claim 15, further comprising computer executable instructions for querying a directory for providing the plurality of web services.

19. The computer program product of claim 14, further computer executable comprising instructions for transforming a format of the request to a format of the web service.

20. The computer program product of claim 19, further comprising computer executable instructions for using a WSDL descriptor of the web service for performing the transformation.

21. A method of providing a failure resistant data processing service, the method comprising the steps of:
using a default data processing service; and
using a web service to provide a substantially similar data processing service if the default data processing service becomes unavailable.

22. The method of claim 21, further comprising the steps of:
determining a plurality of web services by querying a UDDI; and
applying a selection criterion for selection of one of the web services from the plurality of web services.
